(19) United States
(12) Patent Application Publication
(10) Pub. No.: US 2007/0056830 A1
(43) Pub. Date: Mar. 15, 2007

(54) Rack-carousel wash system with walk-through section therein

(76) Inventors: Richard E. Cabak, McKinney, TX (US); James C. Cabak, McKinney, TX (US)

Correspondence Address: RICHARD E. CABAK, 2305 S. CUSTER ROAD, MCKINNEY, TX, 75070, US

(21) Appl. No.: 11/224,508

(22) Filed: Sep. 12, 2005

(51) Int. Cl. B65G 37/00

(52) U.S. Cl. 198/592

(57) ABSTRACT

A commercial dishwashing system has an elongated table structure extending through a dishwasher, the table structure having a longitudinal gap therein and a top side forming a portion of a closed conveyance path. A roller gate is pivotable between a lowered position in which the gate blocks an upper portion of the gap and defines the balance of the closed conveyance path, and a raised position in which the gate unblocks the upper gap portion. A drivable chain, having vertically pivotable links, is used to releasably engage and longitudinally move wash racks around the top side of the table structure. The bottom side of a downwardly extending loop of the chain horizontally extends across the gap at a step-over height. With the gate lifted a worker may access the horizontally inner side of the dishwasher simply by stepping over the bottom chain loop side and walking inwardly through the gap.

### BACKGROUND OF THE INVENTION

The present invention generally relates to material handling apparatus and, in a preferred embodiment thereof, more particularly relates to a rack-carousel wash system having a walk-through area formed through its horizontally extending table top chain conveying path.

Automated commercial dishwashing systems typically utilize a carousel-type rack conveying system in which an elevated table structure extends, via a closed path which bounds an interior portion of the system, through a dishwasher. A motor-driven conveying chain extends continuously along a top side of the table structure and is used to releasably engage and move racks, which typically carry dishes, glasses and silverware to be washed, along the closed top side path of the table structure through the dishwasher.

Because of the construction of this closed rack conveyance path in conventional carousel-type rack conveying systems, the dishwasher must have a substantial floor space area devoted thereto horizontally outside of the closed conveying path to enable a worker to inspect, service and repair the dishwasher. This is because to service the dishwasher from its inner side (i.e., the side of the dishwasher which faces the interior of the closed rack conveyance path) a worker must either crawl under or climb over the table structure to reach the interior of the closed conveyance path and thus the inner side of the refrigerator. The necessity of providing a substantial floor space horizontally outwardly of the dishwasher to provide for convenient service access thereto thus undesirably increases the floor space requirements, and thus the total cost, for the overall dishwashing system.

From the foregoing it can readily be seen that it would be desirable to provide a rack-carousel wash system of this general type in which improved access to the interior side of the dishwasher was provided. It is to this goal that the present invention is primarily directed.

### SUMMARY OF THE INVENTION

In carrying out principles of the present invention, in accordance with a preferred embodiment thereof, a specially designed article conveying system, representatively a rack-carousel wash system, is provided. As representatively illustrated, the rack-carousel wash system comprises a dishwasher, and an elevated table structure extending through the dishwasher and having a top side extending horizontally along a longitudinal portion of a closed conveyance path having a longitudinal walk-through gap therein.

A roller gate is pivotally secured to an end portion of the table structure for selectively (1) blocking an upper portion of the walk-through gap to form the balance of the closed conveying path, or (2) unblocking the upper portion of the walk-through gap. A drive chain extends and is rotationally drivable along the top side of the table structure to releasably engage wash rack structures and move them longitudinally along the closed conveyance path. The drive chain has adjacent pairs of links, the links in such adjacent pairs thereof being pivotable relative to one another about horizontal axes. The drive chain further has a downwardly extending loop with a bottom side portion extending horizontally across a lower portion of the walk-through gap at a convenient step-over height.

When a worker needs access to the horizontally inner side of the dishwasher he simply pivots the roller gate to unblock the upper portion of the gap, and walks inwardly through the gap while stepping over the bottom chain loop side portion extending along a lower portion of the gap. This unique capability of the wash system to permit a worker to simply walk through a gap in the table structure permits the horizontally outer side of the dishwasher to be placed closely adjacent a wall, thereby significantly reducing the overall floor space that needs to be dedicated to the system, while still permitting convenient maintenance/service access to the washing machine (via its horizontally inner side).

According to other aspects of the invention, the chain may be conveniently driven by a motor drivingly coupled thereto, with a chain tensioning assembly operatively coupled to the chain, with at least some of the chain links having upwardly projecting lugs for releasably engaging a rack structure and moving it longitudinally around the closed conveyance path. Representatively, the conveyorized wash system further comprises a hollow guard structure extending across a bottom portion of the gap, with the bottom side portion of the chain loop longitudinally extending through the guard structure. Alternatively, the bottom chain loop side portion could be closely adjacent the floor, or recessed into a floor trench at the bottom of the gap.

A variety of modifications could be made to this unique walk-through article conveying apparatus without departing from principles of the present invention. As examples, but not by way of limitation, while it is preferred that the elongated, flexible rack drive structure is a chain with vertically pivotable links, such elongated flexible rack drive structure could alternatively be an appropriately configured continuous flexible drive belt. Additionally, while the illustrated article conveying apparatus is representatively a rack-carousel wash system it could be a variety of other types of conveying systems for moving other types of articles, if desired, without departing from principles of the present invention.

### BRIEF DESCRIPTION OF THE DRAWING

FIG. 1 is a simplified, somewhat schematic top plan view of a specially designed rack-carousel wash system embodying principles of the present invention;

FIG. 2 is an enlargement of the dashed area “2” in FIG. 1;

FIG. 3 is an enlarged scale, partially cut away side elevational view of a portion of the wash system taken generally along line 3-3 of FIG. 1; and

FIG. 3A is a schematic cross-sectional detail view through an alternate embodiment of a lower part of the wash system walk-through portion illustrated in FIG. 3.

### DETAILED DESCRIPTION

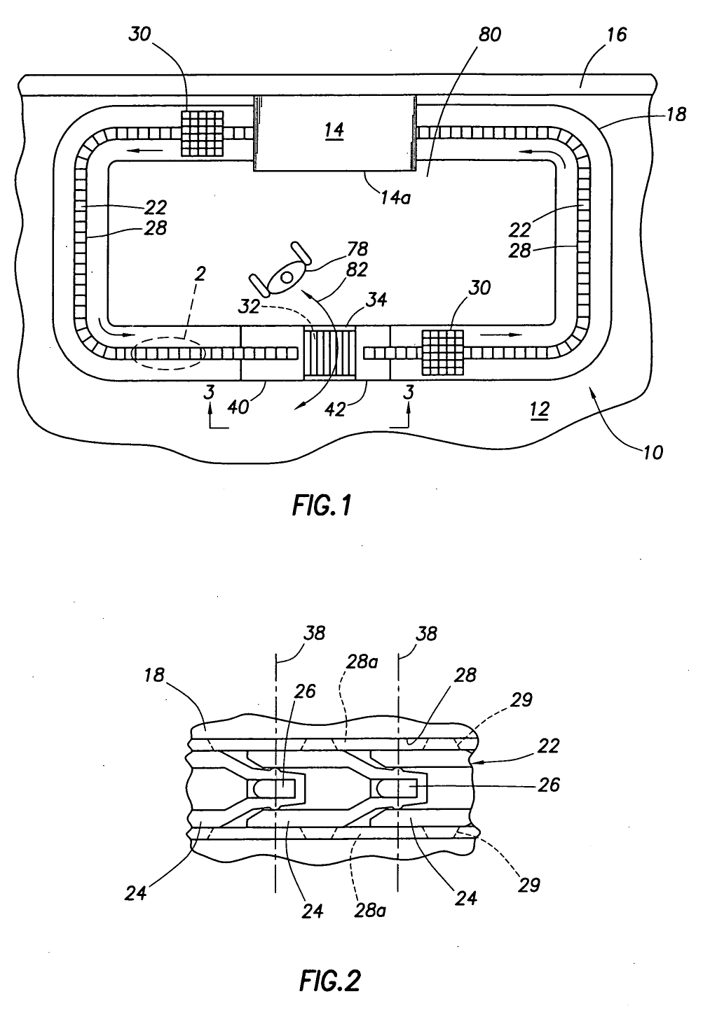

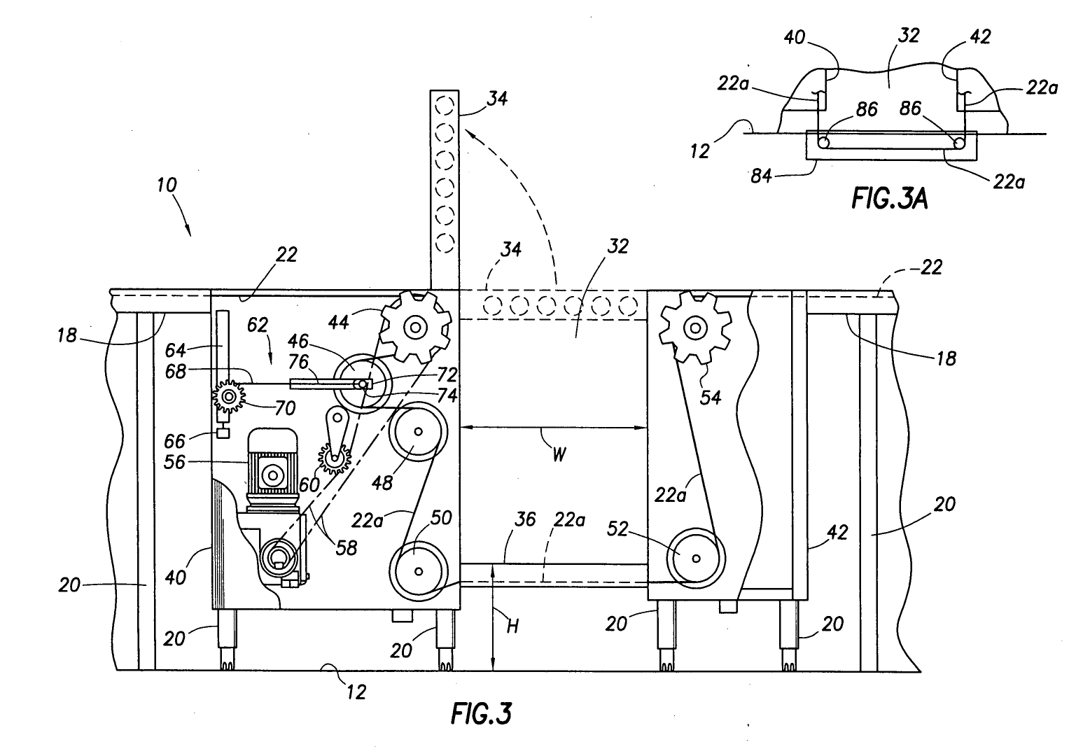

Referring initially to FIGS. 1 and 3, this invention provides an improved rack-carousel wash system 10 for washing dishes, glasses and silverware in a commercial kitchen setting. The system 10 rests on a floor 12 and includes a pass-through dishwasher 14 positioned against a wall 16 (see FIG. 1). Extending through the dishwasher 14 is an elevated support table structure 18 having a closed path configuration (representatively of an elongated rectangular shape, but having a wide variety of possible alternate configurations) and being held in an elevated position relative to the floor 12 by various spaced apart vertical support legs 20.

With additional reference now to FIG. 2, an elongated, flexible drive structure, representatively an electric motor-driven drive chain 22 having pivotally interconnected links 24 with upstanding drive lugs 26 thereon (see FIG. 2), extends along the top side of the elevated table structure 18, in a track 28 formed on the top side of the table structure 18. To captively retain the chain 22 within the track 28, side tabs 29 on the links 24 (see FIG. 2) are slidingly received in undercut laterally opposing grooves 28a in the track 28. During operation of the system 10, the chain link lugs 26 engage bottom edge portions of racks 30 (adapted to hold dirty dishes, glasses and silverware) and drive the racks 30 (see FIG. 1) in a representatively counterclockwise direction over the top side of the closed path support table structure 18 through the dishwasher 14.

In conventional rack-carousel wash systems of this general type, the dishwasher 14 must be spaced outwardly apart from the wall 16 a considerable distance to provide access to the dishwasher since is difficult for a worker to enter the interior of the closed path table structure—the worker must crawl under the table or somehow climb over it. The previous necessity of positioning the dishwasher a considerable distance away from the wall 16 undesirably increases the floor space which must be devoted to the system 10.

According to a key aspect of this invention, the dishwasher 14 may be positioned directly against the wall 16, as shown in FIG. 1, due to the unique incorporation in the table structure of a walk-through area or gap 32 as may be best seen in FIG. 3. A top portion of the walk-through area 32 is normally spanned by an upwardly pivotable roller lift gate 34 of a generally conventional construction. As illustrated in FIG. 3, the roller lift gate 34 may be pivoted between a dotted line horizontal operating position, and an upwardly pivoted solid line access position. In its horizontal operating position the lowered lift gate 34 extends across a top end portion of the walk-through area and defines a section of the previously mentioned closed path support table structure 18 along a top side of which the conveyor chain 22 and its driven racks 30 are routed. In its upwardly pivoted access position the lifted gate 34 opens the previously blocked upper portion of the walk-through area 32 and temporarily opens a gap (i.e., the walk-through area 32) in the closed conveyance path of the support table structure 18.

Extending horizontally across a bottom portion of the walk-through area 32 is a suitable hollow chain guard structure 36. As can be seen in FIG. 3, in general the chain 22 has a downwardly extending loop portion 22a that vertically passes downwardly to the guard 36 on opposite sides of the walk-through area 32 and horizontally passes through the guard structure 36. To facilitate the formation and maintenance of the vertical loop 22a in the chain 22 at the walk-through area 32, the link-to-link pivot axes 38 in the conveyor chain 22 (see FIG. 2) are horizontally oriented instead of being vertically oriented in accordance with the conventional practice utilized in carousel-type rack conveying systems.

As may best be seen in FIG. 3, the overall drive table structure 18 includes an elevated drive housing 40 and an elevated tail housing 42 positioned on opposite sides of the walk-through area or gap 32. The conveyor chain 22 is routed rightwardly along the top side of the drive housing 40 and then drops into the drive housing 40 wherein the chain 22 passes sequentially around a chain drive sprocket 44, a slack take-up pulley 46, an idler sprocket 48, and an idler pulley 50. From the idler pulley 28 a horizontal bottom side portion of the downwardly looped portion 22a of the chain 22 passes rightwardly through the guard structure 36 and into the interior of the tail housing 42 wherein the chain is passed sequentially around an idler pulley 52 and an idler sprocket 54. From the idler sprocket 54 the chain 22 continues rightwardly along the top side of the portion of the table structure 18 to the right of the tail housing 42.

The conveyor chain 22 is driven through its overall looped conveyance path described above by an electric motor 56 disposed within the drive housing 40 and drivingly coupled to the drive sprocket 44 by a main drive chain 58 engaged and automatically tensioned by a spring-loaded slack tensioning sprocket 60. Slack take-up pulley 46 is engaged, and resiliently biased leftwardly, to tension the conveyor chain 22, by a suitable conventional chain tensioning assembly 62 that representatively includes a gas spring 64 exerting a downward resilient force on a force evener bar 66 (seen in end view in FIG. 3).

The opposite ends of the bar 66 have first ends of chains 68 connected thereto and passing upwardly over an opposed pair of rotationally supported equalizing sprockets 70 (only one of which is visible in FIG. 3). The second ends of the chains 68 are anchored to slide members 72 secured to the opposite ends of a translatable shaft 74 to which the slack take-up pulley 46 is rotationally secured. The slide members 72 are slidably received in horizontally elongated slots 76 disposed within the drive housing 40. As can be seen, the downward-resilient force exerted on the bar 66 is converted by the tensioning assembly 62 into a resilient, leftwardly directed force exerted on the take-up pulley 46, which, in turn, automatically takes out slack in the conveyor chain 22.

When a worker 78 (see FIG. 1) needs to work on the dishwasher 14 he simply turns off the chain drive motor 56, lifts up the roller lift gate 34 to its FIG. 3 solid line access position, and steps over the chain guard structure 36 through the now opened walk-through area or gap 32 into the interior 80 of the closed path table structure 18 (as indicated by the double-ended arrow 82 in FIG. 1) to access the dishwasher 14. When the worker 78 is finished with the dishwasher 14 he simply walks outwardly through the area 32 (as also indicated by the double-ended arrow 82), re-lowers the roller gate 34, and re-starts the system 10. Racks 30 are simply pushed rightwardly along the rollers of the lowered gate 34 by following racks 30 driven by the lugs 26 on the chain 22.

As can be seen, the unique provision of the walk-through area 32 permits the worker 78 to simply walk through the normally closed path table structure 18 without the necessity of crawling under it or climbing over it. By way of example and not of limitation, the width W of the walk-through area 32 (see FIG. 3) is preferably at least about 24″, and the height of the horizontal chain guard structure 36 in a lower end portion of the walk-through area 32 is of a convenient “step-over” height (i.e., a height over which a worker may easily step), preferably in the range of from about 8″ to about 10″.

A variety of modifications could be made to this unique walk-through structure without departing from principles of the present invention. For example, while it is preferred that the elongated, flexible rack drive structure 22 is a chain with vertically pivotable links, such elongated flexible rack drive structure could alternatively be an appropriately configured continuous flexible drive belt. Additionally, while the chain guard structure 36 is representatively shown as disposed somewhat above the floor 12 in a lower portion of the walk-through area 32 it could alternately be disposed at floor level.

As a further alternative, schematically depicted in FIG. 3A, the above-floor chain guard structure 36 could be eliminated and the horizontal bottom side portion of the chain loop 22a routed through a covered floor trench area 84 over suitable idler pulleys 86 within the trench area. Moreover, the roller gate 34 does not have to be pivotally mounted but could be, for example, temporarily removed when interior system access through the walk-through gap 32 is desired. Finally, while the illustrated conveying apparatus 10 is representatively a rack-carousel wash system it could be a variety of other types of article conveying systems, if desired, without departing from principles of the present invention.

The foregoing detailed description is to be clearly understood as being given by way of illustration and example only, the spirit and scope of the present invention being limited solely by the appended claims.

What is claimed is:

1. Article conveying apparatus comprising:
an elongated floor-supportable table structure having an upwardly facing top side extending horizontally along a longitudinal portion of a closed conveyance path, said support structure (1) forming a vertical barrier between first and second floor areas respectively disposed horizontally outwardly and inwardly of said table structure, and (2) having a horizontal walk-through gap therein with a longitudinal portion of said table structure being movable between a first position in which it extends across and blocks a top portion of said walk-through gap and defines the balance of said closed conveyance path; and a second position in which it unblocks said top portion of said walk-through gap; and
an elongated continuous flexible drive structure extending and being rotationally drivable along said top side of said support structure to releasably engage an article and move it longitudinally along said closed conveyance path, said drive structure having a downwardly extending loop with a bottom side portion extending horizontally across a lower portion of said walk-through gap at a step-over height,
whereby by moving said longitudinal portion of said support structure from said first position to said second position a worker may walk through said gap, from one to the other of said first and second floor areas, by simply stepping over said bottom side portion of said drive structure loop.

2. The article conveying apparatus of claim 1 wherein:
said conveying apparatus is a part of a rack-carousel wash system, and said flexible drive structure is configured to releasably engage a rack structure and move it longitudinally around said closed conveyance path.

3. The article conveying apparatus of claim 2 wherein:
said rack-carousel wash system includes a dishwasher through which a portion of said closed conveyance path extends.

4. The article conveying apparatus of claim 1 wherein:
said longitudinal portion of said table structure is supported on an end portion of said table structure for vertical pivotal movement relative thereto between said first and second positions.

5. The article conveying apparatus of claim 1 wherein:
said longitudinal portion of said table structure is a roller gate.

6. The article conveying apparatus of claim 1 wherein:
said elongated continuous flexible drive structure is a chain having adjacent pairs of links, the links in said adjacent pairs thereof being pivotable relative to one another about horizontal axes.

7. The article conveying apparatus of claim 6 wherein:
said top side of said table structure has a longitudinally extending track disposed therein and having opposing undercut lateral recesses therein, and
said links of said chain have side tabs disposed thereon and movably received in said opposing lateral recesses.

8. The article conveying apparatus of claim 6 further comprising:
a motor drivingly coupled to said chain, and
a chain tensioning assembly operatively coupled to said chain.

9. The article conveying apparatus of claim 6 wherein:
at least some of said chain links have upwardly projecting lugs for releasably engaging an article and moving it longitudinally around said closed conveyance path.

10. The article conveying apparatus of claim 1 wherein:
said step-over height is in the range of from about 8 inches to about 10 inches.

11. The article conveying apparatus of claim 1 wherein:
said conveying structure further comprises a hollow guard structure extending across a lower portion of said gap, and
said bottom side portion of said downwardly extending flexible drive structure loop longitudinally extends through said guard structure.

12. The article conveying apparatus of claim 1 wherein:
said bottom side portion of said downwardly extending flexible drive structure loop is closely adjacent the floor.

13. The article conveying apparatus of claim 1 wherein:
said conveying structure further comprises a floor depression extending along the bottom side of said gap, and
said bottom side portion of said downwardly extending flexible drive structure loop longitudinally extends through the floor depression.

14. A rack-carousel wash system comprising:
a dishwasher;
an elevated table structure extending through the dishwasher and having a top side extending horizontally along a longitudinal portion of a closed conveyance path having a longitudinal walk-through gap therein;
a roller gate operative to selectively (1) block an upper portion of said walk-through gap to form the balance of said closed conveying path, or (2) unblock said upper portion of said walk-through gap; and
a drive chain extending and being rotationally drivable along said top side of said table structure to releasably engage rack structures and move them longitudinally along said closed conveyance path, said drive chain having adjacent pairs of links, the links in said adjacent pairs thereof being pivotable relative to one another about horizontal axes, said drive chain further having a downwardly extending loop with a bottom side portion extending horizontally across a lower portion of said walk-through gap at a step-over height.

15. The rack-carousel wash system of claim 14 wherein:
said dishwasher has a horizontally outer side positioned closely adjacent a wall.

16. The rack-carousel wash system of claim 14 further comprising:
a motor drivingly coupled to said chain, and
a chain tensioning assembly operatively coupled to said chain.

17. The rack-carousel wash system of claim 14 wherein:
at least some of said chain links have upwardly projecting lugs for releasably engaging a rack structure and moving it longitudinally around said closed conveyance path.

18. The rack-carousel wash system of claim 14 wherein:
said wash system further comprises a hollow guard structure extending across a lower portion of said gap, and
said bottom side portion of said downwardly extending chain loop longitudinally extends through said guard structure.

19. The rack-carousel system of claim 14 wherein:
said bottom side portion of said downwardly extending chain loop is closely adjacent the floor.

20. The rack-carousel system of claim 14 wherein:
said wash system further comprises a floor depression extending along the bottom side of said gap, and
said bottom side portion of said downwardly extending chain loop longitudinally extends through the floor depression.
